(19) United States
(12) Patent Application Publication
(10) Pub. No.: US 2016/0066119 A1
(43) Pub. Date: Mar. 3, 2016

(54) SOUND EFFECT PROCESSING METHOD AND DEVICE THEREOF

(71) Applicant: Tencent Technology (Shenzhen) Company Limited, Shenzhen (CN)

(72) Inventors: Xiayu WU, Shenzhen (CN); Lian GAO, Shenzhen (CN); Xuejian JIANG, Shenzhen (CN)

(73) Assignee: Tencent Technology (Shenzhen) Company Limited, Shenzhen (CN)

(21) Appl. No.: 14/937,630

(22) Filed: Nov. 10, 2015

Related U.S. Application Data
(63) Continuation of application No. PCT/CN2014/078745, filed on May 29, 2014.

(30) Foreign Application Priority Data
Aug. 13, 2013 (CN) 201310351562.6

(51) Int. Cl. H04S 7/00

(52) U.S. Cl. CPC H04S 7/303

(57) ABSTRACT

A sound effect processing method includes obtaining audio data in a scene; obtaining a display region and determining a target audio, the target audio including the audio data in the display region and the audio data in a region that is beyond the display region and within a threshold value; and playing the target audio. Audios in the area near the display region will be played if only the threshold value is positive, and discontinuous sound will not appear when the sounding object moves beyond and nearly the display region. In this solution, it's not necessary to process all audio data in the scene, instead of that, the audio playing region is controllable; thereby ensuring the sounding object can be sensed.

### CROSS-REFERENCE TO RELATED APPLICATIONS

This application is a continuation of International Application No. PCT/CN2014/ 078745, filed on May 29, 2014, which claims priority to Chinese Patent Application No. 201310351562.6, filed on Aug. 13, 2013, both of which are hereby incorporated by reference in their entireties.

### FIELD

The present disclosure relates to information processing field, and more particularly to a sound effect processing method and a device thereof.

### BACKGROUND

Sound effect is an effect brought by sounds, so as to enhance real feeling, ambience or drama message of a scene. The so-call sound includes tone and effect sound, such as digital sound effect and ambient sound effect, etc.

For example, the ambient sound effect is to process the sound via a digital sound processor, so that the sound has different spatial characteristics, like in a hall, an opera house, a cave, a stadium, and the like. The ambient audio effect is processed with ambient filtration, ambient shift, ambient reflection, or ambient transition, thus the listener feels like being in different environments. Such a sound effect processing is widely used in sound cards of computers, and also used in music center gradually.

Sound effect is widely used in game software, which has following types according to the current games.

1. Types according to audio format and making method.

(1) Single tone sound effect, which is an individual sound effect with one single way (one type of audio file formats) file. Most of sound effects in games are single tone, which is called to sound, and controlled positions by the program.

(2) Composite sound effect, which includes several sounds that are composed by a program during the game. Some games specially design a composite sound effect engine for sound, which has advantages of reusing and controlling download burden of the sounds, and abundant changes; and has disadvantage of difficult making and complex technical requirements.

(3) Musical tone sound effect, like one piece of music which appears when entering a map. Such a sound effect pertains to music making field, which is produced by music maker.

2. Types according to functions of sound effects.

(1) Interface sound effect, which is used in interface operations. Such sound effect will run through the whole process of games, such as menu pop-up and withdraw, mouse selecting, or dragging objects, etc..

(2) NPC (Non-Player Character) sound effect, which includes all sound effects related to the character, such as footsteps, sound of running, sound of dying, cry when attacked, and the like.

(3) Environmental sound effect, such as wind, water ripples, sound of waterfall, or twitter, etc..

(4) Sound effect of skills, such as attacking sounds, falchion wielding, lance thrusting, kick, hit, or explosion, etc..

As an example of game software, the 2D (two Dimensions) games have two manners for processing dimensional positioning of the sounds.

One way is to allow the sound to play within a display area of the screen and shield the sound beyond the display area of the screen, and then change the acoustic phase to make the sound feel like in left or right movement. Such a solution will generate discontinuous sound if a game unit for trigger the sound is moving on or out of the edges of the screen. Another way is allowing all sounds in a game scene to play, and changing the acoustic phase to make the sound feel like in left or right movement. Such a solution may not generate discontinuous sound in the edges of the screen, however when the game scene is too big, a game unit hard to be sensed is needed to be used.

Therefore, the solution for solving the problems of discontinuous sound takes up too much system source and causes a sounding object hard to be sensed.

### SUMMARY

The present disclosure provides a sound effect processing method and a device thereof, which takes up less system source, and prevent discontinuous sound while ensuring the sounding object can be sensed.

Accordingly, a sound effect processing method includes: obtaining audio data in a scene; obtaining a display region and determining a target audio, the target audio including the audio data in the display region and the audio data in a region which is beyond the display region and within a threshold value; and playing the target audio.

A sound effect processing device includes a hardware processor and a non-transitory storage medium accessible to the hardware processor. The non-transitory storage medium is configured to store units including: an audio obtaining unit, configured to obtain audio data in a scene; a region obtaining unit, configured to obtain a display region; an audio determination unit, configured to determine a target audio which includes the audio data in the display region and the audio data in a region which is beyond the display region and within a threshold value; and a playing unit, configured to play the target audio determined by the audio determination unit.

By this token, the present has advantages as following. The audio to be played is a target audio in a region that is within the threshold value that is wider than the display region. Audios in the area near the display region will be played if only the threshold value is positive, and discontinuous sound will not appear when the sounding object moves beyond and nearly the display region. In this solution, it's not necessary to process all audio data in the scene, instead of that, the audio playing region is controllable; thereby ensuring the sounding object can be sensed.

### BRIEF DESCRIPTION OF THE DRAWINGS

To explain the technical solutions of the embodiments of the present disclosure, accompanying drawings used in the embodiments are followed. Apparently, the following drawings merely illustrate some embodiments of the disclosure, but for persons skilled in the art, other drawings can be obtained without creative works according to these drawings.

FIG. 1 is a flowchart of the method according to an embodiment of the present disclosure;

FIG. 2 is schematic view of partition of the display region according to an embodiment of the present disclosure;

FIG. 3 is a block diagram of the device according to an embodiment of the present disclosure;

FIG. 4 is a block diagram of the device according to another embodiment of the present disclosure; and

FIG. 5 is a block diagram of the device according to one more embodiment of the present disclosure.

### DETAILED DESCRIPTION OF THE DRAWINGS

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” or “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module or unit may include memory (shared, dedicated, or group) that stores code executed by the processor.

The exemplary environment may include a server, a client, and a communication network. The server and the client may be coupled through the communication network for information exchange, such as sending/receiving identification information, sending/receiving data files such as splash screen images, etc. Although only one client and one server are shown in the environment, any number of terminals or servers may be included, and other devices may also be included.

The communication network may include any appropriate type of communication network for providing network connections to the server and client or among multiple servers or clients. For example, communication network may include the Internet or other types of computer networks or telecommunication networks, either wired or wireless. In a certain embodiment, the disclosed methods and apparatus may be implemented, for example, in a wireless network that includes at least one client.

In some cases, the client may refer to any appropriate user terminal with certain computing capabilities, such as a personal computer (PC), a work station computer, a server computer, a hand-held computing device (tablet), a smart phone or mobile phone, or any other user-side computing device. In various embodiments, the client may include a network access device. The client may be stationary or mobile.

A server, as used herein, may refer to one or more server computers configured to provide certain server functionalities, such as database management and search engines. A server may also include one or more processors to execute computer programs in parallel.

The solutions in the embodiments of the present disclosure are clearly and completely described in combination with the attached drawings in the embodiments of the present disclosure. Obviously, the described embodiments are only a part, but not all, of the embodiments of the present disclosure. On the basis of the embodiments of the present disclosure, all other embodiments acquired by those of ordinary skill in the art under the precondition that no creative efforts have been made shall be covered by the protective scope of the present disclosure.

Other aspects, features, and advantages of this disclosure will become apparent from the following detailed description when taken in conjunction with the accompanying drawings. Apparently, the embodiments described thereinafter merely a part of embodiments of the present disclosure, but not all embodiments. Persons skilled in the art can obtain all other embodiments without creative works, based on these embodiments, which pertains to the protection scope of the present disclosure.

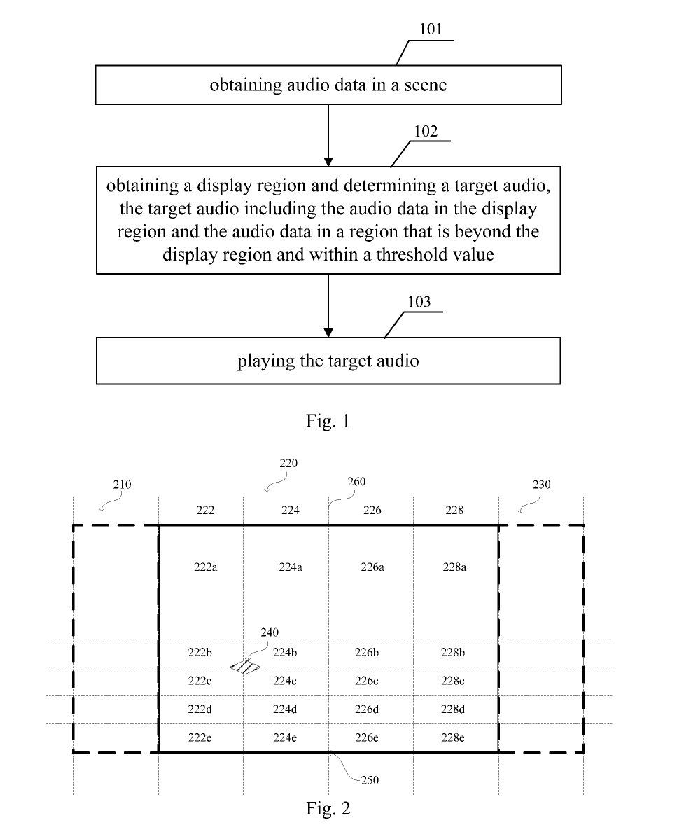

As shown in FIG. 1, the embodiment of the present disclosure provides a sound effect processing method including the following steps implemented by a terminal device:

Step 101, the terminal device obtains audio data in a scene. The scene may be a game scene displayed on a display of the user terminal

For example, the audio data in the scene may be all audio data in the scene where a sounding object is located. Here, the sounding object may include any objects displayed in a video game or an application that is running in a user terminal For example, the sounding object may be a human character in the video game, an artificial object in the video game, a monster in the video game, or any other objects that may generate sound in a game or an application.

Step 102, the terminal device obtains a display region and determines a target audio. The target audio may include the audio data in the display region and the audio data in a region which is beyond the display region and within a threshold value.

The threshold value is set to control a playing region of the audio data. A larger threshold value means that more audio data may be played, by which discontinuous sound effect may not happen easily. Generally, the threshold value cannot be negative or zero. Here, the threshold value is a positive number. Thus, if only the threshold value is a positive, the audio data in a region near the display region will be played, when the sounding object is moved to a region near the display region, discontinuous sound effect is prevented. The threshold value can be set according to actual demands, for example according to some parameters such as moving speed of the sounding object, or the period of determining the audio data. The present disclosure provides a preferable embodiment with the threshold value being set as one fourth distance of the display region, but which is not limited in the present disclosure.

The present disclosure further provides an optional method of determining the target audio. It should be noticed that, the present embodiment determines an audio playing region which is larger than the area of an actual audio playing region. Following examples are provided to illustrate the embodiments, which are not limiting. Optionally, the method of determining the target audio may include setting a volume attenuation of the audio data which is beyond the threshold value of the display region to infinity. Here, the value of “infinity” may be implemented by using a very large constant number defined by the underlying computer language, the operating system, or the game software. For example, infinity may be the maximum number supported by the operating system.

Step 103, the terminal device plays the target audio.

In this embodiment, the audio to be played is a target audio in a region that is within the threshold value that is wider than the display region. Audios in the area near the display region will be played if only the threshold value is positive, and discontinuous sound will not appear when the sounding object moves beyond and nearly the display region. In this solution, it's not necessary to process all audio data in the scene, instead of that, the audio playing region is controllable; thereby ensuring the sounding object can be sensed.

The present disclosure is further aiming at a representation for a 3D (three Dimensions) sound effect. Following is a further description for it.

Furthermore, the present embodiment provides a method of changing sound effect in horizontal region.

For example, the method above further includes obtaining a horizontal region where a sounding object is located, and obtaining a first attenuation of a volume corresponding to the horizontal region. A vertical bisector located in a middle of the display region may be served as a sound receiving origin. The display region may be divided into a first number of horizontal regions with the vertical bisector being used as a benchmark. The volume of the audio data in each horizontal region may gradually attenuate with a first setting value according to a distance from the vertical bisector.

So the method of playing target audio includes playing the target audio according to the first attenuation.

Furthermore, the present disclosure can obtain a 3D sound effect besides the sound effect changing in horizontal region. For example, the method further includes obtaining a vertical region where the sounding object is located, and obtaining a second attenuation of the volume corresponding to the vertical region; a bottom of the vertical bisector being served as the sound receiving origin, and a vertical movement region of the sounding object being divided into a second number of vertical regions with the bottom of the display region being used as a benchmark, and the volume of the audio data in each vertical region gradually attenuating with a second setting value according to a distance from the bottom. The sound receiving origin represents the point that the user is located in a scene. Generally, the sound receiving origin may be determined based on the perspective relationship of the displayed scene. The sound receiving origin may be at a midpoint of a line that is closest to the player. For example, in a two dimensional video game scene, the game player may be located in the bottom of the vertical bisector. The sound receiving origin may be moved to other points or locations in the scene by the user in a game setting or other setting options. Accordingly, the distance between the sound receiving origin and the sounding object may be used to determine the sound attenuation. When the attenuation is determined based on the relative distance between the sound receiving origin and the sounding object, the sound effect makes the player feels that the sounding object sounds louder when it is closer to the player and sounds weaker when it is farther away, which generates a sense of location positioning on hearing.

So the method of playing target audio includes playing the target audio according to a total attenuation of the first and the second attenuations for the volume.

As a preferable embodiment, the first number mentioned above is four, and the first setting value is 15%, and/or, the second number is four, and the second setting value is 5%.

The preferable embodiment is achieved by setting the obvious difference with 3db (Decibel) that is able to be identified by ears, namely according a change of 25% of loudness, which may have a better efficiency. Following is an example of a 2D game where the sound effect is widely used. But the game software is not the only one application scene using 3D sound effect; the example should not be understood as the only one definition.

The obvious difference that can be identified by ears is 3db, namely a change within 25% of loudness. Referring to FIG. 2, the region with thick and real lines illustrates the display region 220 (namely the screen region), the left area 210 and the right area 230 with thick and broken lines illustrate ¼ of the display region (namely ¼ of the screen region). For example, the sound receiving origin 250 is the point with 100% volume of the sound, and the acoustic phase is the median playing point. The sound receiving origin 250 may be set with other preset volume of the sound, for example, 50%, 40%, or other numbers to generate a better game sound effect. In the game software, the game unit is an object or character that can be distinguished in the game, which can replace the sounding object in this embodiment.

The sound receiving origin 250 is set in the midpoint of the bottom, and the volume and the acoustic phase are controlled according to position difference between the sounding object and the sound receiving origin. For example, the focus has the maximum volume, and the acoustic phase is located in the middle. And the sound receiving origin and a sound attenuation system are created by art perspective relationship. Referring to FIG. 2, the horizontal region and the vertical region are divided by broken lines.

The horizontal changes: the screen region 220 is divided into four equal parts: 222, 224, 226, and 228. The bottom of the median bisector 260 is the sound receiving origin 250. The game sounding object changes the acoustic phase according to the position of the median bisector 260, and attenuates the volume linearly. For example, the volume is attenuated with 30% when the game sounding object reaching to the screen edge, namely the volume is attenuated with 15% for every ¼ of the screen. The median bisector 260 may also be called as a vertical bisector.

The volume in the ¼ of the screen which is beyond the screen edge is attenuated to negative infinity.

The vertical changes: the art surface is divided into four equal parts. For example, region 222 includes four parts: 222b, 222c, 222d, and 222e. The volume is attenuated linearly from bottom to up according to the longitudinal position of the game sounding object. The sound receiving origin 250 is located in the bottommost. When the game sounding object reaches to the topmost, the volume is attenuated with 20%, namely the volume is attenuated with 5% for every ¼ of the art surface.

Here, areas 222a, 224a, 226a, and 228a may correspond to the base map in the third dimension in a side perspective view. These areas 222a, 224a, 226a, and 228a may not exist in a top perspective view. In either case, the sound attenuation may be only related to the distance between the sounding object and the sound receiving point.

As shown in FIG. 2, the attenuation in the left beyond the broken line out of the screen is to negative infinity. The volume is attenuated with 30% when moving leftwards to the screen edge, the volume is attenuated with 20% when moving up to the top edge of the art surface, and the volume is attenuated with 50% when moving to the left corner of the art surface.

As shown in FIG. 2, the attenuation in the right beyond the broken line out of the screen is to negative infinity. The volume is attenuated with 30% when moving rightwards to the screen edge, the volume is attenuated with 20% when moving up to the top edge of the art surface, and the volume is attenuated with 50% when moving to the right corner of the art surface.

In the FIG. 2, the rhombic area illustrates a sounding object 240, which has volume attenuations with a horizontal attenuation of 15% and a vertical attenuation of 15%, namely a total attenuation with 30%.

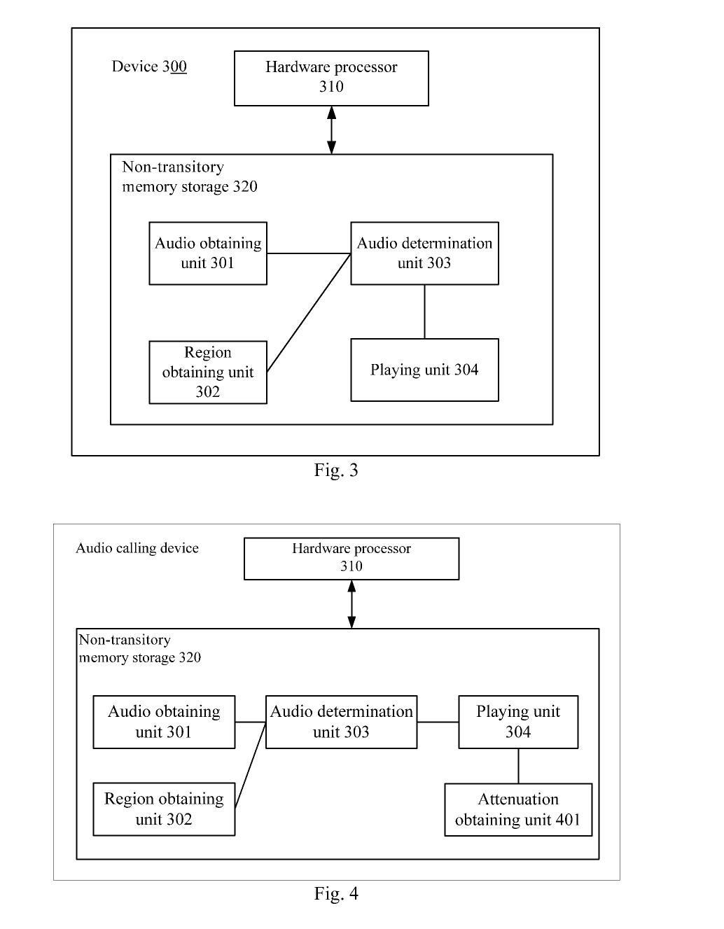

The present disclosure also provides a sound effect processing device, as shown in FIG. 3, which includes:

An audio obtaining unit 301, configured to obtain audio data in a scene.

For example, the audio data in the scene can be all audio data in the scene where sounding objects are located.

A region obtaining unit 302, configured to obtain a display region.

An audio determination unit 303, configured to determine a target audio which includes the audio data in the display region and the audio data in a region which is beyond the display region and within a threshold value.

A playing unit 304, configured to play the target audio determined by the audio determination unit 302. For example, the playing unit 304 may play the determined target audio though a speaker in the audio circuit of the device.

In this embodiment, the audio to be played is a target audio in a region that is within the threshold value that is wider than the display region. Audios in the area near the display region will be played if only the threshold value is positive, and discontinuous sound will not appear when the sounding object moves beyond and nearly the display region. In this solution, it's not necessary to process all audio data in the scene, instead of that, the audio playing region is controllable; thereby ensuring the sounding object can be sensed.

The threshold value is set to control a playing region of the audio data. A larger threshold value means that more audio data may be played, by which discontinuous sound effect may not happen easily. Generally, the threshold value cannot be negative or zero. Here, the threshold value is a positive number. Thus, if only the threshold value is a positive, the audio data in a region near the display region will be played, when the sounding object is moved to a region near the display region, discontinuous sound effect is prevented. The threshold value can be set according to actual demands, for example according to some parameters such as moving speed of the sounding object, or the period of determining the audio data. The present disclosure provides a preferable embodiment with the threshold value being set as one fourth (¼) distance of the display region, but which is not limited in the present disclosure.

For example, the audio determination unit 303 is configured to set a volume attenuation of the audio data which is beyond ¼ distance of the display region to infinity.

The present disclosure further provides an optional method of determining the target audio. It should be noticed that, the present embodiment determines an audio playing region which is larger than an actual audio playing region. There are many screen methods for doing this; it's not limited to the following example. Optionally, the method of determining the target audio may include: the audio determination unit 303 is configured to set a volume attenuation of the audio data which is beyond the threshold value of the display region to infinity.

The present disclosure is further aiming at a representation of a 3D (three Dimensions) sound effect. Following is a further description for it.

Furthermore, the present embodiment provides a method of changing sound effect in horizontal region.

For example, the region obtaining unit 302 is further configured to obtain a horizontal region where a sounding object is located, and obtaining a first attenuation of a volume corresponding to the horizontal region; a vertical bisector located in a middle of the display region being served as a sound receiving origin, and the display region being divided into a first number of horizontal regions with the vertical bisector being used as a benchmark.

As shown in FIG. 4, the device further includes an attenuation obtaining unit 401 configured to obtain a first attenuation of a volume corresponding to the horizontal region. And the volume of the audio data in each horizontal region gradually attenuates with a first setting value according to a distance from the vertical bisector.

The playing unit 304 is configured to play the target audio according to the first attenuation.

Furthermore, the present disclosure can obtain a 3D sound effect besides the sound effect changing in horizontal region. For example, the region obtaining unit 302 is further configured to obtain a vertical region where the sounding object is located; and a bottom of the vertical bisector being served as the sound receiving origin, and a vertical movement region of the sounding object being divided into a second number of vertical regions with the bottom of the display region being used as a benchmark.

The attenuation obtaining unit 401 is further configured to obtain a second attenuation of the volume corresponding to the vertical region; and the volume of the audio data in each vertical region gradually attenuating with a second setting value according to a distance from the bottom.

The playing unit 304 is further configured to play the target audio according to a total attenuation of the first and the second attenuations for the volume.

As a preferable embodiment, the first number mentioned above is four, and the first setting value is 15%, and/or, the second number is four, and the second setting value is 5%.

The preferable embodiment is achieved by setting the obvious difference with 3db (Decibel) that is able to be identified by ears, namely according a change of 25% of loudness, which may have a better efficiency. Following is an example of a 2D game where the sound effect is widely used. But the game software is not the only one application scene using 3D sound effect; the example should not be understood as the only one definition.

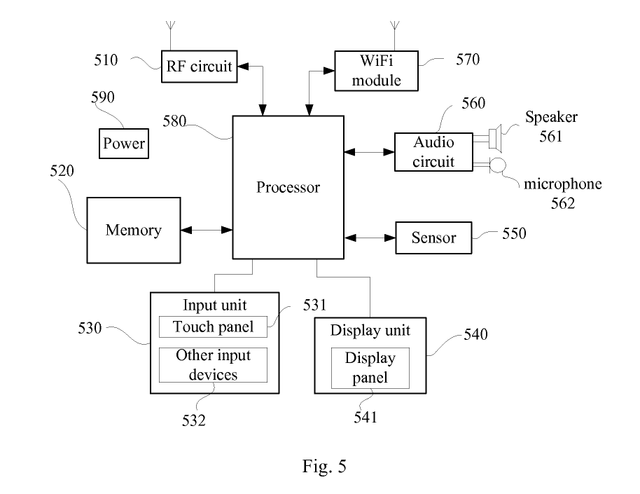

The present disclosure also provides a sound effect processing device according to another embodiment, as shown in FIG. 5. To simplify the expatiation, only some relevant portions associated with the present embodiment are illustrated, other details un-displayed can be reviewed in the method described above. Specifically, the device may be any terminal device such as mobile phone, Tablet PC, PDA (Personal Digital Assistant), POS (Point of Sales), or car PC. Following is an example of a mobile phone.

FIG. 5 is a block diagram of a partial device related to a terminal device such as a mobile phone. For example, the mobile phone includes a radio frequency (RF) circuit 510, a memory 520, an input unit 530, a display unit 540, a sensor 550, an audio circuit 560, a wireless fidelity (WiFi) module 570, a processor 580, and a power 590, etc.. It's understood for persons skilled in the art that, the structure of a mobile phone illustrated in FIG. 5 is not limited, some components can be added or omitted, or some combinations or arrangement can be included.

Following is a detailed description of the structure of the mobile phone by combining with FIG. 5.

The RF circuit 510 is configured to receive and sending signals during calling or process of receiving and sending message. Specially, the RF circuit 510 will receive downlink information from the base station and send it to the processor 580; or send uplink data to the base station. Generally, the RF circuit 510 includes, but is not limited to, an antenna, at least one amplifier, a transceiver, a coupler, a low noise amplifier (LNA), a diplexer, and the like. In addition, the RF circuit 40 can communicate with network or other devices by wireless communication. Such wireless communication can use any one communication standard or protocol, which includes, but is not limited to, Global System of Mobile communication (GSM), (General Packet Radio Service, GPRS), (Code Division Multiple Access, CDMA), (Wideband Code Division Multiple Access, WCDMA), (Long Term Evolution, LTE), email, or (Short Messaging Service, SMS).

The memory 520 is configured to store software program and module which will be run by the processor 580, so as to perform multiple functional applications of the mobile phone and data processing. The memory 530 mainly includes storing program area and storing data area. For example, the storing program area can store the operating system, at least one application program with required function (such as sound playing function, image playing function, etc.). The storing data area can store data established by mobile phone according to actual using demand (such as audio data, phonebook, etc.) Furthermore, the memory 520 can be high-speed random access memory, or nonvolatile memory, such as disk storage, flash memory device, or other volatile solid-state memory devices.

The input unit 530 is configured to receive the entered number or character information, and the entered key signal related to user setting and function control of the mobile phone 500. For example, the input unit 530 includes a touch panel 531 or other input devices 532. The touch panel 531 is called as touch screen, which can collect user's touch operations thereon or nearby (for example the operations generated by fingers of user or stylus pen, and the like, touching on the touch panel 531 or touching near the touch panel 531), and drive the corresponding connection device according to the preset program. Optionally, the touch panel 531 includes two portions including a touch detection device and a touch controller. Specifically, the touch detection device is configured to detect touch position of the user and detecting signals accordingly, and then sending the signals to the touch controller. Subsequently, the touch controller receives touch information from the touch detection device, and converts it to contact coordinates which are to be sent to the processor 580, and then receives command sent by the processor 580 to perform. In addition, the touch panel 531 can be implemented is forms of resistive type, capacitive type, infrared type and surface acoustic wave type. Besides the touch panel 531, the input unit 530 can include, but is not limited to other input devices 532, such as one or more selected from physical keyboard, function keys (such as volume control keys, switch key-press, etc.), a trackball, a mouse, and an operating lever, etc..

The display unit 540 is configured to display information entered by the user or information supplied to the user, and menus of the mobile phone. For example, the display unit 540 includes a display panel 541, such as a Liquid Crystal Display (LCD), or an Organic Light-Emitting Diode (OLED). Furthermore, the display panel 541 can be covered by the touch panel 531, after touch operations are detected on or near the touch panel 531, they will be sent to the processor 580 to determine the type of the touching event. Subsequently, the processor 580 supplies the corresponding visual output to the display panel 541 according to the type of the touching event. As shown in FIG. 5, the touch panel 531 and the display panel 541 are two individual components to implement input and output of the mobile phone, but they can be integrated together to implement the input and output in some embodiments.

Furthermore, the mobile phone 500 includes at least one sensor 550, such as light sensors, motion sensors, or other sensors. Specifically, the light sensors includes ambient light sensors for adjusting brightness of the display panel 541 according to the ambient light, and proximity sensors for turning off the display panel 541 and/or maintaining backlight when the mobile phone is moved to the ear side. Accelerometer sensor as one of the motion sensors can detect the magnitude of accelerations in every direction (Triaxial, generally), and detect the magnitude and direction of gravity in an immobile status, which is applicable to applications of identifying attitudes of the mobile (such as switching between horizontal and vertical screens, related games, magnetometer attitude calibration, etc.), vibration recognition related functions (such as pedometer, percussion, etc.). And the mobile phone 500 also can configure other sensors (such as gyroscopes, barometers, hygrometers, thermometers, infrared sensors, etc.) whose detailed descriptions are omitted here.

The audio circuit 560, the speaker 561 and the microphone 562 supply an audio interface between the user and the mobile phone. Specifically, the audio data is received and converted to electrical signals by audio circuit 560, and then transmitted to the speaker 561, which are converted to sound signal to output. On the other hand, the sound signal collected by the speaker is then converted to electrical signals which will be received and converted to audio data. Subsequently, the audio data are output to the processor 580 to process, and then sent to another mobile phone via the RF circuit 510, or sent to the memory 520 to process further.

WiFi pertains to short-range wireless transmission technology providing a wireless broadband Internet, by which the mobile phone can help the user to receive and send email, browse web, and access streaming media, etc.. Although the WiFi module 570 is illustrated in FIG. 5, it should be understood that, WiFi module 570 is not a necessary for the mobile phone, which can be omitted according the actual demand without changing the essence of the present disclosure.

The processor 580 is a control center of the mobile phone, which connects with every part of the mobile phone by various interfaces or circuits, and performs various functions and processes data by running or performing software program/module stored in the memory 520 or calling data stored in the memory 520, so as to monitor the mobile phone. Optionally, the processor 580 may include one or more processing units. Preferably, the processor 580 can integrate with application processors and modem processors, for example, the application processors include processing operating system, user interface and applications, etc.; the modern processors are used for performing wireless communication. It can be understood that, it's an option to integrate the modern processors to the processor 580.

Furthermore, the mobile phone 500 may include a power supply (such as battery) supplying power for each component, preferably, the power supply can connect with the processor 580 by power management system, so as to manage charging, discharging and power consuming.

In addition, the mobile phone 500 may include a camera, and a Bluetooth module, etc., which are not illustrated.

In this embodiment, the processor 580 in the device may include the following functions of obtaining audio data in a scene; obtaining a display region and determining a target audio, the target audio including the audio data in the display region and the audio data in a region which is beyond the display region and within a threshold value; and playing the target audio.

For example, the audio data in the scene can be all audio data in the scene where a sounding object is located.

In this embodiment, the audio to be played is a target audio in a region that is within the threshold value that is wider than the display region. Audios in the area near the display region will be played if only the threshold value is positive, and discontinuous sound will not appear when the sounding object moves beyond and nearly the display region. In this solution, it's not necessary to process all audio data in the scene, instead of that, the audio playing region is controllable; thereby ensuring the sounding object can be sensed.

The threshold value is set to control a playing region of the audio data. A larger threshold value means that more audio data may be played, by which discontinuous sound effect may not happen easily. Generally, the threshold value cannot be negative or zero. Here, the threshold value is a positive number. Thus, if only the threshold value is a positive, the audio data in a region near the display region will be played, when the sounding object is moved to a region near the display region, discontinuous sound effect is prevented. The threshold value can be set according to actual demands, for example according to some parameters such as moving speed of the sounding object, or the period of determining the audio data. The present disclosure provides a preferable embodiment with the threshold value being set as one fourth distance of the display region, but which is not limited in the present disclosure.

For example, the processor 580 is configured to set a volume attenuation of the audio data which is beyond ¼ distance of the display region to infinity.

The present disclosure further provides an optional method of determining the target audio. It should be noticed that, the present embodiment determines an audio playing region which is larger than an actual audio playing region. There are many screen methods for doing this; it's not limited to the following example. Optionally, the method of determining the target audio may include: the processor 580 is configured to set a volume attenuation of the audio data which is beyond the threshold value of the display region to infinity.

The present disclosure is further aiming at a representation of a 3D (three Dimensions) sound effect. Following is a further description for it.

Furthermore, the present embodiment provides a way of changing sound effect in horizontal region. For example, the processor 580 is further configured to obtain a horizontal region where a sounding object is located, and obtaining a first attenuation of a volume corresponding to the horizontal region; a vertical bisector located in a middle of the display region being served as a sound receiving origin, and the display region being divided into a first number of horizontal regions with the vertical bisector being used as a benchmark.

The processor 580 is further configured to obtain a first attenuation of a volume corresponding to the horizontal region. And the volume of the audio data in each horizontal region gradually attenuates with a first setting value according to a distance from the vertical bisector. And then the target audio will be played according to the first attenuation.

Furthermore, the present disclosure can obtain a 3D sound effect besides the sound effect changing in horizontal region. For example, the processor 580 is further configured to obtain a vertical region where the sounding object is located; and a bottom of the vertical bisector being served as the sound receiving origin, and a vertical movement region of the sounding object being divided into a second number of vertical regions with the bottom of the display region being used as a benchmark. And the processor 580 is further configured to obtain a second attenuation of the volume corresponding to the vertical region; and the volume of the audio data in each vertical region gradually attenuating with a second setting value according to a distance from the bottom; and playing the target audio according to a total attenuation of the first and the second attenuations for the volume.

As a preferable embodiment, the first number mentioned above is four, and the first setting value is 15%, and/or, the second number is four, and the second setting value is 5%.

The preferable embodiment is achieved by setting the obvious difference with 3db (Decibel) that is able to be identified by ears, namely according a change of 25% of loudness, which may have a better efficiency. Following is an example of a 2D game where the sound effect is widely used. But the game software is not the only one application scene using 3D sound effect; the example should not be understood as the only one definition.

It should be noticed that, the device in the embodiment mentioned above is divided into multiple units according to function logic, which is not limited however, and it is viable if only the corresponding functions can be performed. In addition, the designation for every unit is just for distinguishing each other, which is not limited here.

Moreover, it's understood for person skilled in the art to accomplish part of or whole steps in the embodiment mentioned above by instructing the related hardware with program. Such program can be stored in a computer-readable storage medium such as read-only memory, magnetic or optical disk, etc..

While the disclosure has been described in connection with what are presently considered to be the most practical and preferred embodiments, it is to be understood that the disclosure is not to be limited to the disclosed embodiments, but on the contrary, is intended to cover various modifications and equivalent arrangements included within the spirit and scope of the disclosure.

What is claimed is:

1. A sound effect processing method, comprising:
obtaining, by a terminal device, audio data in a scene;
obtaining, by the terminal device, a display region and determining a target audio, the target audio comprising audio data in the display region and audio data in a region that is beyond the display region and within a threshold value; and
playing, by the terminal device, the target audio.

2. The method according to claim 1, wherein determining the target audio comprises:
setting, by the terminal device, a volume attenuation of the audio data that is beyond the threshold value of the display region to infinity.

3. The method according to claim 2, wherein the threshold value is one fourth distance of the display region.

4. The method according to claim 1, further comprising:
obtaining, by the terminal device, a horizontal region where a sounding object is located, and obtaining a first attenuation of a volume corresponding to the horizontal region;
setting a vertical bisector located in a middle of the display region as a sound receiving origin;
dividing the display region into a first number of horizontal regions with the vertical bisector being used as a benchmark; and
gradually attenuating the volume of the audio data in each horizontal region with a first setting value according to a distance from the vertical bisector,
wherein playing target audio comprises playing the target audio according to the first attenuation.

5. The method according to claim 4, further comprising:
obtaining, by the terminal device, a vertical region where the sounding object is located;
obtaining a second attenuation of the volume corresponding to the vertical region;
setting a bottom of the vertical bisector as the sound receiving origin;
dividing a vertical movement region of the sounding object into a second number of vertical regions with the bottom of the display region being used as a benchmark; and
gradually attenuating the volume of the audio data in each vertical region with a second setting value according to a distance from the bottom,
wherein playing target audio comprises playing the target audio according to a total attenuation of the first and the second attenuations for the volume.

6. The method according to claim 5, wherein the first number is four, and the first setting value is 15%, and/or, the second number is four, and the second setting value is 5%.

7. A device, comprising a hardware processor and a non-transitory storage medium accessible to the hardware processor, the non-transitory storage medium configured to store units comprising:
an audio obtaining unit, configured to obtain audio data in a scene;
a region obtaining unit, configured to obtain a display region;
an audio determination unit, configured to determine a target audio which includes the audio data in the display region and the audio data in a region that is beyond the display region and within a threshold value; and
a playing unit, configured to play the target audio determined by the audio determination unit.

8. The device according to claim 7, wherein the audio determination unit is configured to set a volume attenuation of the audio data that is beyond the threshold value of the display region to infinity.

9. The device according to claim 8, wherein the audio determination unit is configured to set the volume attenuation of the audio data that is beyond one fourth distance of the display region to infinity.

10. The device according to claim 7, wherein the region obtaining unit is further configured to obtain a horizontal region where a sounding object is located; and set a vertical bisector located in a middle of the display region as a sound receiving origin, and divide the display region into a first number of horizontal regions with the vertical bisector as a benchmark;
wherein the device further comprises an attenuation obtaining unit configured to obtain a first attenuation of a volume corresponding to the horizontal region; and the volume of the audio data in each horizontal region gradually attenuating with a first setting value according to a distance from the vertical bisector;
and the playing unit is configured to play the target audio according to the first attenuation.

11. The device according to claim 10, wherein the region obtaining unit is further configured to obtain a vertical region where the sounding object is located; and set a bottom of the vertical bisector as the sound receiving origin, and divide a vertical movement region of the sounding object into a second number of vertical regions with the bottom of the display region as a benchmark;
the attenuation obtaining unit is configured to obtain a second attenuation of the volume corresponding to the vertical region; and gradually attenuate the volume of the audio data in each vertical region with a second setting value according to a distance from the bottom;
and the playing unit is configured to play the target audio according to a total attenuation of the first and the second attenuations for the volume.

12. A device, comprising a hardware processor and a non-transitory storage medium accessible to the hardware processor, the device is configured to:
obtain audio data in a scene;
obtain a display region;
determine a target audio which includes the audio data in the display region and the audio data in a region that is beyond the display region and within a threshold value; and
play the determined target audio.

13. The device according to claim 12, wherein the device is configured to set a volume attenuation of the audio data that is beyond the threshold value of the display region to infinity.

14. The device according to claim 13, wherein the device is configured to set the volume attenuation of the audio data that is beyond one fourth distance of the display region to infinity.

15. The device according to claim 12, further configured to:
obtain a horizontal region where a sounding object is located; and set a vertical bisector located in a middle of the display region as a sound receiving origin, and divide the display region into a first number of horizontal regions with the vertical bisector as a benchmark;
obtain a first attenuation of a volume corresponding to the horizontal region;
attenuate the volume of the audio data in each horizontal region gradually with a first setting value according to a distance from the vertical bisector; and
play the target audio according to the first attenuation.

16. The device according to claim 15, further configured to:
obtain a vertical region where the sounding object is located;
set a bottom of the vertical bisector as the sound receiving origin;
divide a vertical movement region of the sounding object into a second number of vertical regions with the bottom of the display region as a benchmark;
obtain a second attenuation of the volume corresponding to the vertical region;
gradually attenuate the volume of the audio data in each vertical region with a second setting value according to a distance from the bottom; and
play the target audio according to a total attenuation of the first and the second attenuations for the volume.
